(19) United States
(12) Patent Application Publication
(10) Pub. No.: US 2006/0132526 A1
(43) Pub. Date: Jun. 22, 2006

(54) Method for forming a combined printhead alignment pattern

(75) Inventor: Michael Duane Donovan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International Inc.

(21) Appl. No.: 11/017,995

(22) Filed: Dec. 21, 2004

(51) Int. Cl. B41J 29/393

(52) U.S. Cl. 347/19

(57) ABSTRACT

A method for forming a combined printhead alignment pattern includes printing a row of spaced blocks which accommodates both the collection of multiple printhead alignment data pertaining to printhead alignment as between a plurality of printheads and the collection of bi-directional alignment data pertaining to bi-directional alignment for at least one particular printhead, each of the blocks being printed in a single scan direction, but with some of the blocks being printed in a first scan direction and a remainder of the blocks being printed in a second scan direction opposite to the first scan direction.

### BACKGROUND OF THE INVENTION

1. Field of the Invention

The present invention relates to ink jet printers, and, more particularly, to a method for forming a combined printhead alignment pattern for accommodating multiple printhead alignment types within a single pattern.

2. Description of the Related Art

Many ink jet printers include a printhead auto-alignment sensor that may be used to automatically calculate and correct for various printhead misalignments including, for example, horizontal misalignment between two printheads, vertical misalignment between two printheads, bi-directional misalignment of a printhead, and skew misalignment of a printhead. In one printer configuration, for example, the printer performs printhead auto-alignment using a carrier mounted printhead auto-alignment sensor that moves with the printhead carrier across a printed test pattern of ink marks or blocks.

For example, one known technique to determine bi-directional misalignment is to print a plurality of rectangular blocks along the main scanning axis, i.e., the scanning axis of the printhead, with odd blocks printed from left to right and with even blocks printed from right to left with the intent of placing an even block exactly midway between two adjacent odd blocks. After printing, in one technique, the sensor is passed over the pattern to measure the distances between adjacent blocks, such as for example, by using the position encoder of the printhead carrier or by using a timer and the known speed of the sensor. Unequal distances are a measure of bi-directional misalignment which, in one technique, is corrected for by advancing or delaying the firing times when printing right to left so that, in the case of the test pattern, the blocks from bi-directional printing are printed an equal distance apart.

Ink jet printers and all-in-one (AIO) devices that inlude a scanner part and a printer part have increased their reliance on auto alignment, and there is a desire to place more and more information on the auto alignment page. For example, not only are the alignment patterns printed on the page, but instructions are also printed on the page.

What is needed in the art is a method for forming one or more combined alignment patterns on a page, which conserves the printed area on the page taken up by the alignment patterns by combining multiple printhead alignment patterns into a single pattern to form a combined printhead alignment pattern.

### SUMMARY OF THE INVENTION

The present invention provides a method for forming one or more combined alignment patterns on a page, which conserves the printed area on the page taken up by the alignment patterns by combining multiple printhead alignment patterns into a single pattern to form a combined printhead alignment pattern.

The invention, in one exemplary embodiment, is directed to a method for forming a combined printhead alignment pattern, including printing a row of spaced blocks which accommodates both the collection of multiple printhead alignment data pertaining to printhead alignment as between a plurality of printheads and the collection of bi-directional alignment data pertaining to bi-directional alignment for at least one particular printhead, each of the blocks being printed in a single scan direction, but with some of the blocks being printed in a first scan direction and a remainder of the blocks being printed in a second scan direction opposite to the first scan direction.

The invention, in another exemplary embodiment, is directed to a method for forming a combined printhead alignment pattern, including printing a row of spaced blocks which accommodates both the collection of printhead skew data and the collection of bi-directional alignment data pertaining to bi-directional alignment for at least one printhead, each of the blocks being printed in a single scan direction, but with some of the blocks being printed in a first scan direction and a remainder of the blocks being printed in a second scan direction opposite to the first scan direction.

The invention, in still another exemplary embodiment, is directed to a method for use in performing printhead alignment in an imaging apparatus, including forming a combined printhead alignment pattern by printing a row of spaced blocks which accommodates the collection of printhead alignment data pertaining to a plurality of printhead alignment types; and scanning the row with a scanner to obtain the printhead alignment data pertaining to the plurality of printhead alignment types.

An advantage of the present invention is the fewer patterns are printed on a page to obtain the same amount of printhead alignment data from conventional patterns, whereby reducing the printed area on the page and saving ink.

Another advantage is that since fewer patterns are printed, less time is needed to scan the patterns.

Yet another advantage is that since the printed area is reduced on a page, a full set of alignment patterns for multiple printheads may be printed on a single page.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2 is an exemplary depiction of one of the printheads of FIG. 1, with the printhead being projected over a sheet of print media.

FIG. 3 is a diagrammatic depiction of a portion of a printhead carrier carrying a color printhead and a monochrome printhead.

FIG. 4 is a diagrammatic depiction of a printhead alignment pattern arranged in accordance with the present invention.

FIG. 5 is a portion of a printhead alignment page including a plurality of printhead alignment patterns, with three of four of the printhead alignment patterns being configured and arranged in accordance with the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

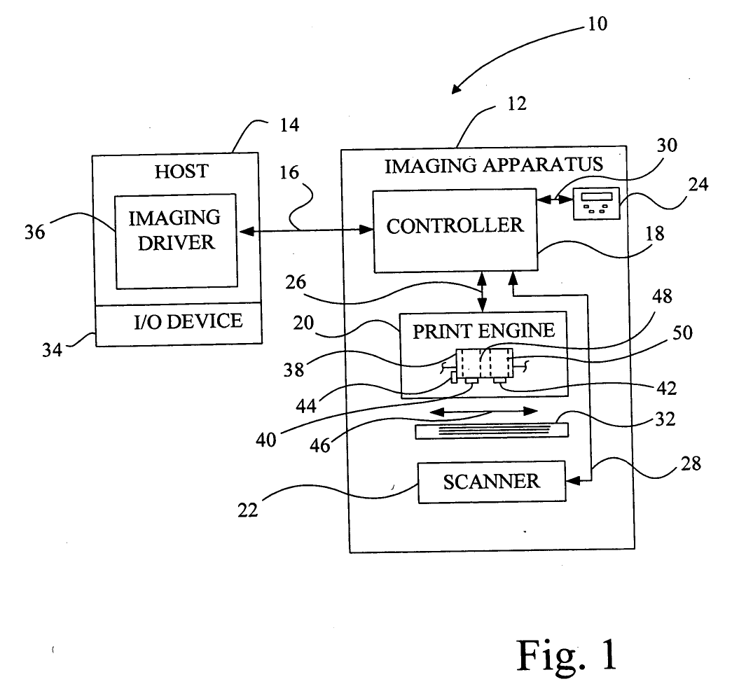

Referring now to the drawings and particularly to FIG. 1, there is shown a diagrammatic depiction of an imaging system 10 embodying the present invention. Imaging system 10 may include an imaging apparatus 12 and a host 14, with imaging apparatus 12 communicating with host 14 via a communications link 16.

Imaging apparatus 12 may communicate with host 14 via a standard communication protocol, such as for example, universal serial bus (USB) or Ethernet. As used herein, the term “communications link” is used to generally refer to structure that facilitates electronic communication between two components, and may operate using wired or wireless technology. Communications link 16 may be established, for example, by a direct cable connection, wireless connection or by a network connection such as for example an Ethernet local area network (LAN).

Alternatively, imaging apparatus 12 may be a standalone unit that is not communicatively linked to a host, such as host 14. For example, imaging apparatus 12 may take the form of a multifunction machine, e.g., an all-in-one (AIO) device, that includes standalone copying and facsimile capabilities, in addition to optionally serving as a printer when attached to a host, such as host 14. Imaging apparatus 12 includes, for example, a controller 18, a print engine 20, a scanner 22 and a user interface 24.

Controller 18 includes a processor unit and associated memory, and may be formed as an Application Specific Integrated Circuit (ASIC). Controller 18 communicates with print engine 20 via a communications link 26. Controller 18 communicates with scanner 22 via a communications link 28. Controller 18 communicates with user interface 24 via a communications link 30. Communications links 26, 28 and 30 may be established, for example, by using standard electrical cabling or bus structures, or by wireless connection.

In the context of the examples for imaging apparatus 12 given above, print engine 20 may be, for example, an ink jet print engine configured for forming an image on a sheet of print media 32, such as a sheet of paper, transparency or fabric. As an ink jet print engine, for example, print engine 20 operates one or more printing cartridges and/or printheads to eject ink droplets onto the sheet of print media 32 in order to reproduce text and/or images.

Host 14 may be, for example, a personal computer including an input/output (I/O) device 34, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 36, e.g., printer driver software for imaging apparatus 12; Imaging driver 36 is in communication with controller 18 of imaging apparatus 12 via communications link 16. Imaging driver 36 facilitates communication between imaging apparatus 12 and host 14, and may provide formatted print data to imaging apparatus 12, and more particularly, to print engine 20.

Alternatively, however, all or a portion of imaging driver 36 may be located in controller 18 of imaging apparatus 12. For example, where imaging apparatus 12 is a multifunction machine having standalone capabilities, controller 18 of imaging apparatus 12 may include an imaging driver configured to support a copying function using scanner 22, and/or a fax-print function, and may be further configured to support a printer function. Scanner 22 may be, for example, a bed type scanner with a movable scan bar, or a scanner that transports paper under a stationary scan bar. In this embodiment, the imaging driver facilitates communication of formatted print data, as determined by a selected print mode, to print engine 20, and facilitates communication of scanned image data to controller 18.

Print engine 20 may include, for example, a reciprocating printhead carrier 38, a color ink jet printhead 40, a monochrome ink jet printhead 42 and (optionally) a reflectance sensor 44. Controller 18 serves to process print data and to operate print engine 20 during printing, as well as to operate scanner 22, process image data obtained via scanner 22, and process printhead alignment data obtained by scanner 22 or reflectance sensor 44. In order for print data from host 14 to be properly printed by print engine 20, the rgb data generated by host 14 is converted into data compatible with print engine 20 and printheads 40, 42. Alternatively, monochrome ink jet printhead 42 may be replaced by another color printhead, such as a photo printhead for jetting diluted color and mono inks.

Printhead carrier 38 transports ink jet printheads 40, 42 and reflectance sensor 44 in a reciprocation manner along a bi-directional main scan axis 46 over an image surface of the sheet of print media 32 during printing and/or sensing operations. Printhead carrier 38 may be mechanically and electrically configured to mount, carry and facilitate one or more or each of a color printhead cartridge 48 and a monochrome printhead cartridge 50. Each color printhead cartridge 48 may include, for example, an ink reservoir containing a supply of ink, to which at least one respective color ink jet printhead 40 is attached. Each monochrome printhead cartridge 50 may include, for example, an ink reservoir containing a supply of ink, to which at least one respective monochrome ink jet printhead 42 is attached.

In one system using cyan, magenta, yellow and black inks, printhead carrier 38 may carry four printheads, such as printhead 40, with each printhead carrying a nozzle array dedicated to a specific color of ink, e.g., cyan, magenta, yellow and black. As a further example, a single printhead, such as printhead 40, may include multiple ink jetting arrays, with each array associated with one color of a plurality of colors of ink, and printhead carrier 38 may be configured to carry two or more printheads, such as printheads 40, 42.

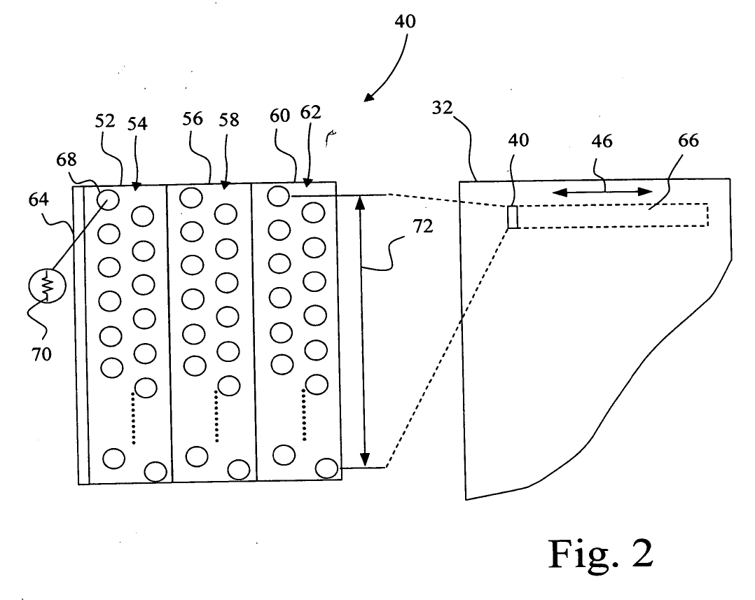

FIG. 2 shows one exemplary configuration of printhead 40, which includes a cyan nozzle plate 52 including a nozzle array 54, a yellow nozzle plate 56 including a nozzle array 58, and a magenta nozzle plate 60 including a nozzle array 62, for respectively ejecting cyan (C) ink, yellow (Y) ink, and magenta (M) ink. In addition, printhead 40 may include a memory 64 for storing information relating to printhead 40: and/or imaging apparatus 12. For example, memory 64 may be formed integral with printhead 40, or may be attached to printhead cartridge 48.

As further illustrated in FIGS. 1 and 2, printhead carrier 38 is controlled by controller 18 to move the printheads mounted to printhead carrier 38, such as printhead 40 in this example, in a reciprocating manner along main scan axis 46, with each left to right, or right to left movement of printhead carrier 38 along main scan axis 46 over the sheet of print media 32 being referred to herein as a pass. The area traced by a printhead over sheet of print media 32 for a given pass will be referred to herein as a swath, such as for example, swath 66 for printhead 40, as shown in FIG. 2.

In the exemplary nozzle configuration for color printhead 40 shown in FIG. 2, each of nozzle arrays 54, 58 and 62 include a plurality of ink jetting nozzles 68, with each ink jetting nozzle 68 having at least one corresponding heating element 70. The ink jetting nozzles are arranged in two columns in each of arrays 54, 58 and 62. A common ink feed via (not shown) is used to supply ink to each of the ink jetting nozzles 68 of a particular array, but the nozzles 68 may not be an equal distance from the ink feed via. Nozzles 68 that are located closest to the ink feed via will be referred to herein as “nears” and nozzles 68 that are located farther from the ink feed via will be referred to herein as “fars”. For example, within cyan nozzle array 54 of printhead 40 shown in FIG. 2, the left column of nozzles 68 may be nears and the right column of nozzles 68 may be fars, and likewise of nozzle arrays 58 and 62.

As within a particular nozzle array, or as from one nozzle array in comparison to another, the nozzle sizes of the plurality of ink jetting nozzles may vary from a nominal nozzle size due to variations which occur during manufacture of the printhead nozzle plate, e.g., nozzle plates 52, 56, 60, respectively, that includes the respective nozzle array. For example, where nozzle plates 52, 56, 60 are formed from a polyimide or other plastic material, such variation in nozzle diameter may result from the technique used to form the nozzle openings in the nozzle plate, such as for example, through the use of laser ablation in forming the ink jetting nozzles 68 in the polyimide nozzle plate.

A swath height 72 of swath 66 corresponds to the distance between the uppermost and lowermost of the nozzles within an array of nozzles of printhead 40. In this example, the swath height 72 is the same for each of nozzle arrays 54, 58 and 62; however, this need not be the case, i.e., it is possible that the swath heights of nozzle arrays 54, 58 and 62 may be different, either by design or due to manufacturing tolerances.

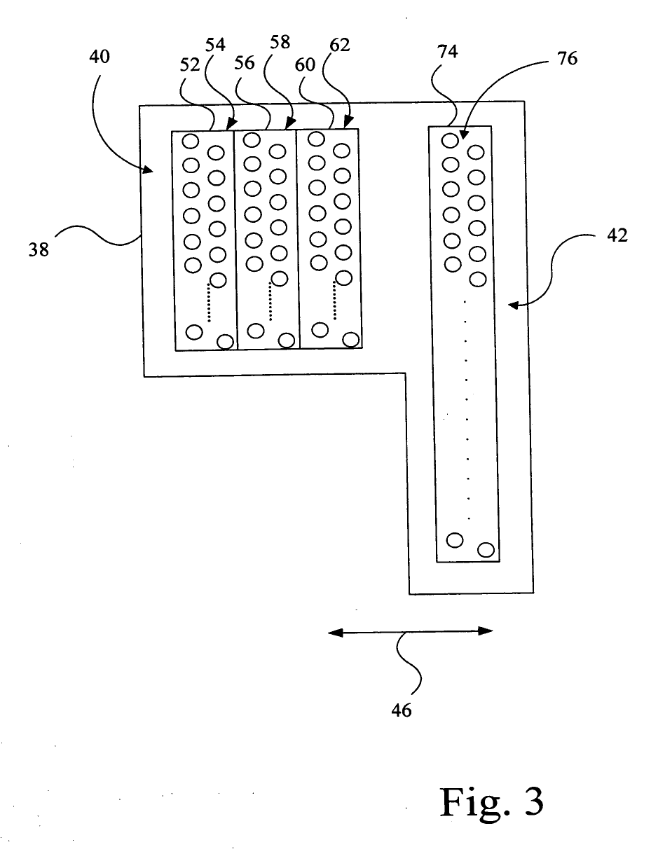

FIG. 3 shows an exemplary relationship of the nozzle plates 52, 56, 60, including nozzle arrays 54, 58 and 62, of color ink jet printhead 40, respectively, and a monochrome nozzle plate 74 including nozzle array 76 of monochrome ink jet printhead 42, when color ink jet printhead 40 and monochrome ink jet printhead 42 are installed in printhead carrier 38. Monochrome nozzle plate 74 may be formed from a polyimide or other plastic material.

Each time one of printhead 40 or printhead 42 is replaced, it is desirable to run a printhead alignment procedure to test and correct for, if necessary, that various alignments with respect to printhead 40 and/or printhead 42. For example, it may be desirable to check the horizontal printhead-to-printhead alignment of printheads 40, 42; the vertical printhead-to-printhead alignment of printheads 40, 42; and various bi-directional alignments for each of printheads 40, 42, such as for example, the nears in a draft mode, the nears in a quality mode, the fars in a draft mode and the fars in a quality mode. To do so, printhead alignment patterns are generated and read to provide alignment values to the imaging apparatus, such as imaging apparatus 12. Traditionally, for each printhead alignment type there is a separate printhead alignment pattern.

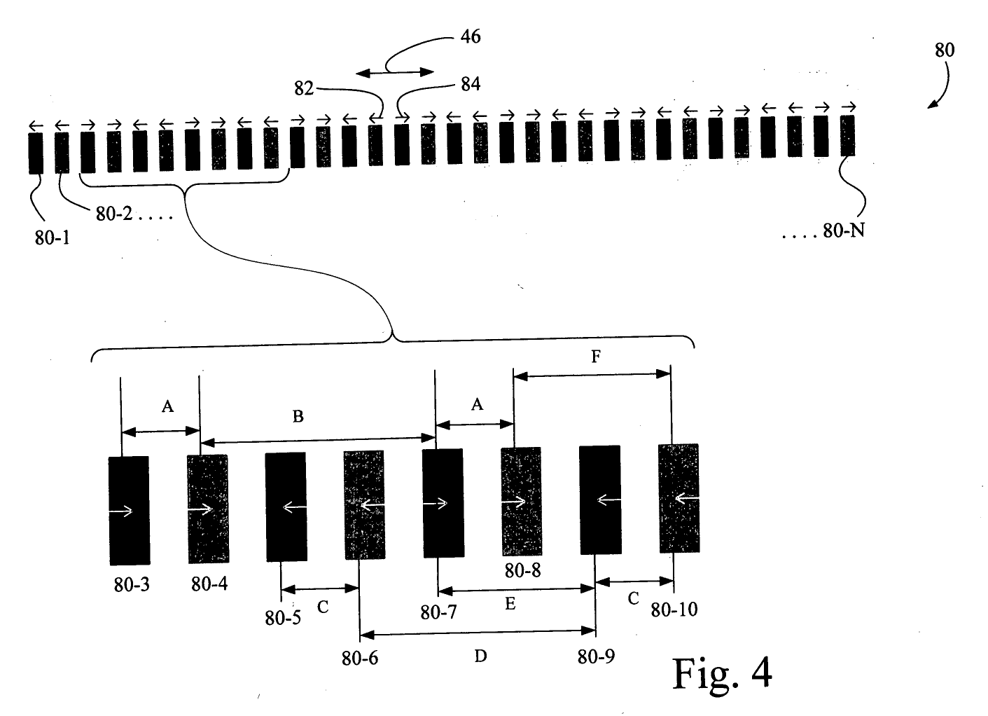

In accordance with the present invention, alignment data corresponding to multiple printhead alignment types is extrapolated from a single alignment pattern. As the term is used in describing the present invention, an alignment pattern is a single row of spaced blocks, such as horizontally spaced, that are formed in a predefined arrangement so as to represent multiple alignment types. The spaced blocks may be oriented vertically or diagonally. Thus, the present invention in essence combines multiple traditional alignment patterns into a single alignment pattern. Combining alignment patterns together allows the total printhead alignment data to be embedded in fewer printhead alignment patterns. For example, referring to FIG. 4, the printhead-to-printhead horizontal alignment pattern used to align printheads 40, 42 may also be used to find the bi-directional (bidi) alignment for the individual printheads, e.g., printhead 40 and/or printhead 42.

More particularly, one embodiment of the present invention provides a method for forming printhead alignment patterns, including printing a row of spaced blocks which accommodates both the collection of multi-head alignment data pertaining to printhead alignment as between a plurality of printheads, e.g., printheads 40, 42, and the collection of bi-directional alignment data pertaining to bi-directional alignment for a particular printhead, such as color printhead 40 and/or monochrome printhead 42, each of the blocks being printed in a single scan direction, but with some of the blocks being printed in a first scan direction and a remainder of the blocks being printed in a second scan direction opposite to the first scan direction.

FIG. 4 shows a printhead alignment pattern 80 formed by a plurality of rectangular blocks, individually identified for convenience as block 80-1 through block 80-N, from left to right, wherein two different printheads are used in forming the blocks in a predefined arrangement. In this example, the light blocks (even numbered blocks) represent blocks printed by a first printhead, such as cyan nozzle array 54 of color printhead 40, and the dark blocks (odd numbered blocks) represent blocks printed by a second printhead, such as monochrome nozzle array 76 of monochrome printhead 42. Thus, in this example, the blocks alternate dark, light, dark, light, etc. across the extent of printhead alignment pattern 80, such that a light block formed by the first printhead, e.g., printhead 40, is positioned between successive blocks formed by printhead 42.

The blocks in printhead alignment pattern 80 are arranged to form a single row of blocks, and each block is printed in a single scan direction, wherein some of the blocks are printed in a first scan direction 82 along bi-directional main scan axis 46 and a remainder of the blocks are printed in a second scan direction 84 along bi-directional main scan axis 46 opposite to the first scan direction 82. The arrows associated with each block represent the direction of travel of printhead carrier 38 when the respective block was printed. Accordingly, in this example, on a particular pass of a particular printhead every fourth block is printed.

Thus, for example, blocks 80-1, 80-5, 80-9, 80-13, etc. are printed by monochrome printhead 42 when monochrome printhead 42 is scanned in scan direction 82 (right-to-left); blocks 80-3, 80-7, 80-11, 80-15, etc. are printed by monochrome printhead 42 when monochrome printhead 42 is scanned in scan direction 84 (left-to-right); blocks 80-2, 80-6, 80-10, 80-14, etc. are printed by color printhead 40 when color printhead 40 is scanned in scan direction 82 (right-to-left); and blocks 80-4, 80-8, 80-12, 80-16, etc. are printed by color printhead 40 when color printhead 40 is scanned in scan direction 84 (left-to-right).

FIG. 4 further shows with respect to 8 exemplary blocks, individually identified as blocks 80-3, 80-4, 80-5, 80-6, 80-7, 80-8, 80-9 and 80-10 of printhead alignment pattern 80, how measurements may be taken to acquire alignment data relating to a plurality of printhead alignment types, e.g., printhead-to-printhead horizontal alignment used to align printheads 40, 42, and bi-directional alignment for each of the individual printheads, e.g., color printhead 40 and monochrome printhead 42. A plurality of distances A, B, C, D, E and F may be determined, for example, by scanning the row of printhead alignment pattern 80 with a scanner, such as scanner 22 or reflectance sensor 44, to obtain the printhead alignment data pertaining to the plurality of printhead alignment types present in printhead alignment pattern 80. For example, where the scanner is the carrier mounted reflectance sensor 44, or scanner 22, the scanning of the row of printhead alignment pattern 80 may occur in a single pass of the scanner.

Distances A and C represent the distance between a mono block to the next color block printed in the same direction. For example, distances A represent the distances between block 80-3 (mono) and block 80-4 (color), and between block 80-7 (mono) and block 80-8 (color), with both mono and color blocks being printed in scan direction 84 (left-to-right). Distances C represent the distances between block 80-5 (mono) and block 80-6 (color), and between block 80-9 (mono) and block 80-10 (color), with both mono and color blocks being printed in scan direction 82 (right-to-left).

Distances B and D represent the distance from a color block to the next mono block-printed in the same direction. Thus, distance B represents the distance from block 80-4 (color) to block 80-7 (mono), with both the color and mono blocks being printed in scan direction 84 (left-to-right). Distance D represents the distance between block 80-6 (color) and block 80-9 (mono), with both the color and mono blocks being printed in scan direction 82 (right-to-left).

Distance E is the distance between two adjacent mono blocks, which are printed in opposite directions e.g., blocks 80-7 and 80-9.

Distance F is the distance between two adjacent color blocks, which are printed in opposite directions, e.g., blocks 80-8 and 80-10

From this data, printhead-to-printhead alignment can be determined for printheads 40, 42 in a manner known in the art, except using the average of 3(A)/average B, or the average (3C)/average D. Horizontal bi-directional mono printhead alignment can be obtained from distances E and bi-directional color printhead alignment can be obtained from distances F.

While the example above was given with respect to color printhead 40 and monochrome printhead 42, those skilled in the art will recognize that the principles of the present invention may be applied to any combination of two or more printheads. For example, monochrome printhead 42 may be replaced with a photo printhead, which may include black, diluted cyan, and diluted magenta inks. As a further example, printhead carrier 38 may be configured to carry three or more printheads, such as a photo printhead in addition to the mono and color printheads.

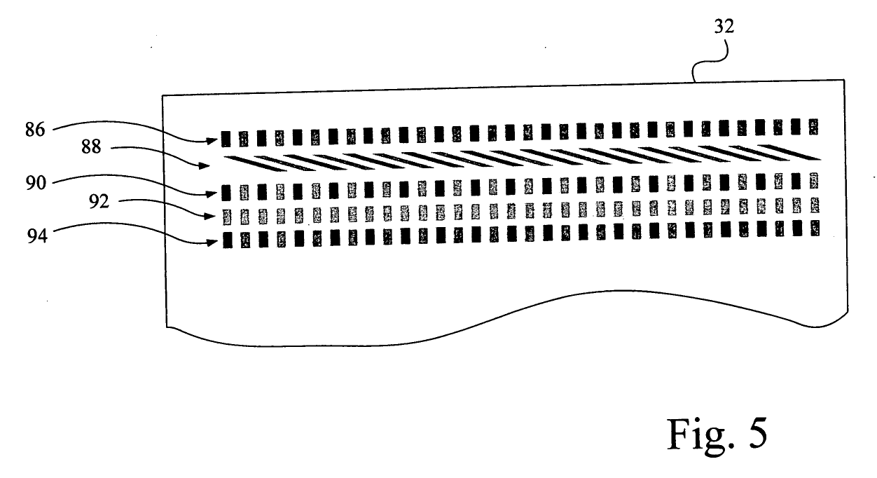

Also, by using the principles of the method of the present invention, other printhead alignment patterns may be combined. For example, the following patterns may be combined, as illustrated in FIG. 5.

Printhead alignment pattern 86 includes patterns for horizontal printhead-to-printhead alignment, quality second printhead bidi alignment, and quality first printhead nears bidi printhead alignment. Here, the term “quality” refers to a printing mode other: than draft. The first printhead may be, for example, color printhead 40. The second printhead may be, for example, monochrome printhead 42. The arrangement and direction of the printing of the blocks of printhead alignment pattern 86 may be the same as that described above with respect to printhead alignment pattern 80.

Printhead alignment pattern 88 includes patterns for vertical printhead-to-printhead alignment, vertical first printhead bidi alignment, and vertical second printhead bidi alignment. The blocks of printhead alignment pattern 88 have a diagonal orientation to accommodate the vertical alignment determination. The arrangement and direction of printing of the blocks of printhead alignment pattern 88 may be the same as that described above with respect to printhead alignment pattern 80.

Printhead alignment pattern 90 includes patterns for draft horizontal printhead-to-printhead alignment, draft second printhead bidi alignment, and draft first printhead nears bidi alignment. The arrangement and direction of printing of the blocks of printhead alignment pattern 90 may be the same as that described above with respect to printhead alignment pattern 80.

Printhead alignment pattern 92 includes a single pattern for quality first printhead far bidi alignment.

Pattern 94 is a printhead skew pattern for two printheads, e.g., printheads 40, 42, forming alternating blocks, e.g., dark, light, dark, light, etc., and wherein the pattern is formed by printing two interleaved half-swaths, with one of the half-swaths being printed with the upper half of the printhead, and the other half-swath being printed with the lower half of the printhead. The above method of combining the patterns may be employed here to combine the skew with a pattern for a first printhead draft far bidi alignment and/or a pattern for a second printhead draft far bidi alignment to conserve space, or as shown, may be a dedicated skew pattern, which in this example, is the combined skew pattern for color printhead 40 and monochrome printhead 42.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for forming a combined printhead alignment pattern, comprising printing a row of spaced blocks which accommodates both the collection of multiple printhead alignment data pertaining to printhead alignment as between a plurality of printheads and the collection of bi-directional alignment data pertaining to bi-directional alignment for at least one particular printhead, each of said blocks being printed in a single scan direction, but with some of said blocks being printed in a first scan direction and a remainder of said blocks being printed in a second scan direction opposite to said first scan direction.

2. The method of claim 1, wherein said row includes blocks printed to accommodate skew correction.

3. The method of claim 1, wherein at least a portion of said blocks have a vertical orientation.

4. The method of claim 1, wherein at least a portion of said blocks have a diagonal orientation.

5. The method of claim 1, wherein said row of spaced blocks is a row of horizontally spaced blocks.

6. The method of claim 1, wherein said combined printhead alignment pattern combines two or more of a horizontal printhead-to-printhead alignment pattern, a first printhead bi-directional alignment pattern and a second printhead bi-directional alignment pattern into a single pattern formed by said row of spaced blocks.

7. The method of claim 1, wherein said combined printhead alignment pattern combines two or more of a horizontal printhead-to-printhead alignment pattern, a quality first printhead bi-directional alignment pattern, and a quality second printhead bi-directional printhead alignment pattern.

8. The method of claim 1, wherein said combined printhead alignment pattern combines two or more of a vertical printhead-to-printhead alignment pattern, a vertical first printhead bi-directional alignment pattern, and a vertical second printhead bi-directional alignment pattern.

9. The method of claim 1, wherein said combined printhead alignment pattern combines two or more of a draft horizontal printhead-to-printhead alignment pattern, a draft first printhead bi-directional alignment pattern, and draft second printhead bi-directional alignment pattern.

10. The method of claim 1, wherein said row of blocks includes:
a first set of blocks printed by a first printhead when said first printhead is scanned in a first scan direction;
a second set of blocks printed by said first printhead when said first printhead is scanned in a second scan direction opposite to said first scan direction;
a third set of blocks printed by a second printhead when said second printhead is scanned in said first scan direction; and
a fourth set of blocks printed by said second printhead when said second printhead is scanned in said second direction opposite to said first direction.

11. The method of claim 10, wherein said first printhead is one of a monochrome printhead and a color printhead, and the second printhead is another monochrome printhead or another color printhead.

12. A method for forming a combined printhead alignment pattern, comprising printing a row of spaced blocks which accommodates both the collection of printhead skew data and the collection of bi-directional alignment data pertaining to bi-directional alignment for at least one printhead, each of said blocks being printed in a single scan direction, but with some of said blocks being printed in a first scan direction and a remainder of said blocks being printed in a second scan direction opposite to said first scan direction.

13. The method of claim 12, wherein said row of spaced blocks is a row of horizontally spaced blocks.

14. The method of claim 12, wherein said combined printhead alignment pattern includes a first printhead bi-directional alignment pattern, a second printhead bi-directional alignment pattern, and a skew pattern in said row of spaced blocks.

15. A method for use in performing printhead alignment in an imaging apparatus; comprising:
forming a combined printhead alignment pattern by printing a row of spaced blocks which accommodates collection of printhead alignment data pertaining to a plurality of printhead alignment types; and
scanning said row with a scanner to obtain said printhead alignment data pertaining to said plurality of printhead alignment types.

16. The method of claim 15, wherein said plurality of printhead alignment types includes printhead alignment as between a plurality of printheads and bi-directional alignment data pertaining to bi-directional alignment for at least one printhead of said plurality of printheads.

17. The method of claim 15, wherein said scanner is a carrier mounted reflectance sensor and scans said row in a single pass.
